(19) United States
(12) Patent Application Publication
(10) Pub. No.: US 2019/0344795 A1
(43) Pub. Date: Nov. 14, 2019

(54) VEHICLE CONTROL SYSTEM, VEHICLE CONTROL METHOD, AND VEHICLE CONTROL PROGRAM

(71) Applicant: HONDA MOTOR CO., LTD., Minato-ku, Tokyo (JP)

(72) Inventors: Atsushi Ishioka, Wako-shi (JP); Kazuyuki Takahashi, Wako-shi (JP); Akihiko Otsu, Wako-shi (JP); Akira Mizutani, Wako-shi (JP); Daichi Kato, Wako-shi (JP)

(21) Appl. No.: 16/473,670

(22) PCT Filed: Feb. 3, 2017
(86) PCT No.: PCT/JP2017/003913

§ 371 Date: Jun. 26, 2019

(51) Int. Cl. B60W 30/18

(52) U.S. Cl. CPC B60W 30/18163; B60W 2550/10; B60W 2420/52; B60W 2420/42; B60W 2550/20

(57) ABSTRACT

A vehicle control system includes: a gate selector configured to select a gate to be merged associated with a path to be merged after passage of the gate among a plurality of gates in accordance with a merging status between vehicles after passage of the gate; and a gate passage controller configured to control a subject vehicle such that the subject vehicle passes through the gate selected by the gate selector.

### TECHNICAL FIELD

The present invention relates to a vehicle control system and a vehicle control method.

### BACKGROUND ART

Conventionally, a merging support system that distributes a merging priority level calculated in accordance with positions of gates and a passage order of the gates to a vehicle in merging after passing through a tollgate in which there are many gates is known (for example, see Patent Document 1). An automated driving vehicle that has acquired information of a merging priority level from this merging support system controls a subject vehicle on the basis of a merging priority level of the subject vehicle and merging priority levels of other vehicles.

### CITATION LIST

### [Patent Literature]

[Patent Document 1]

Japanese Unexamined Patent Application, First Publication No. 2015-102893

### SUMMARY OF INVENTION

### [Technical Problem]

However, the conventional technology only focuses on control after passage of a gate, and taking a status after passage of a gate into account in selecting a gate to pass has not been considered.

The present invention is in consideration of such situations, and one object thereof is to provide a vehicle control system, a vehicle control method, and a vehicle control program capable of selecting a gate to pass for smooth driving.

### [Solution to Problem]

According to an aspect, a vehicle control system includes: a gate selector configured to select a gate associated with a path into which to merge after passage of the gate among a plurality of gates in accordance with a merging status between vehicles after passage of the gate; and a gate passage controller configured to control a subject vehicle such that the subject vehicle passes through the gate selected by the gate selector.

According to another aspect, the gate selector is configured to select a gate on the basis of an aspect of a road after passage of the gate.

According to another aspect, the aspect of the road includes at least one of a shape of the road and a sign of the road.

According to another aspect, the gate selector is configured to select a gate overlapping an area acquired by virtually extending a main line after passage of the gate to a front side.

According to another aspect, the gate selector is configured to select a gate on the basis of behaviors of other vehicles in the past.

According to another aspect, a vehicle control system includes: a gate selector configured to select a gate through which a subject vehicle is to pass on the basis of an aspect of a road after passage of the gate; and a gate passage controller configured to control the subject vehicle such that the subject vehicle passes through the gate selected by the gate selector.

According to another aspect, a vehicle control method uses an in-vehicle computer, the vehicle control method including: selecting a gate associated with a path into which to merge after passage of the gate among a plurality of gates in accordance with a merging status between vehicles after passage of the gate; and controlling a subject vehicle such that the subject vehicle passes through the selected gate.

According to another aspect, a non-transitory computer-readable storage medium that stores a vehicle control program causes an in-vehicle computer to execute: selecting a gate associated with a path into which to merge after passage of the gate among a plurality of gates in accordance with a merging status between vehicles after passage of the gate; and controlling a subject vehicle such that the subject vehicle passes through the selected gate.

### [Advantageous Effects of Invention]

According to the above aspects, the gate selector controls the subject vehicle such that the subject vehicle passes through a gate through which to merge associated with a path into which to merge after passage of the gate among a plurality of gates in accordance with a merging status between vehicles after passage of the gate, and accordingly, the vehicle can be smoothly controlled after the passage.

According to the above aspects, the gate selector is configured to select a gate through which to merge on the basis of behaviors of other vehicles in the past, and accordingly, the vehicle can be more smoothly controlled after passage of the gate.

According to the above aspects, a gate through which a subject vehicle is to pass is selected on the basis of an aspect of a road after passage of the gate, and the subject vehicle is controlled such that the subject vehicle passes through the selected gate, whereby the vehicle can be smoothly controlled after the passage.

### BRIEF DESCRIPTION OF DRAWINGS

FIG. 1 is a configuration diagram of a vehicle system 1 including an automated driving control unit 100.

FIG. 2 is a diagram showing a view in which a relative position and a posture of a subject vehicle M with respect to a running lane L1 are recognized by a subject vehicle position recognizer 122.

FIG. 3 is a diagram showing a view in which a target locus is generated on the basis of a recommended lane.

FIG. 4 is a flowchart showing the flow of a process executed by a gate selector 123A and a gate passage controller 123B.

FIG. 5 is a diagram showing one example of a view in which a gate associated with a lane is selected.

FIG. 6 is a diagram showing another example of a view in which a gate associated with a lane is selected.

FIG. 7 is a diagram (1) showing selection of a gate through which to merge.

FIG. 8 is a diagram (2) showing selection of a gate through which to merge.

FIG. 9 is a diagram showing one example of tollgate information 63.

FIG. 10 is a diagram showing one example of a traffic information providing system including a subject vehicle M in which a vehicle system 1 is mounted.

FIG. 11 is a flowchart showing the flow executed by the vehicle system 1 and a traffic information management server 300.

FIG. 12 is a diagram showing one example of a locus along which a vehicle has run in an inner side area AR1 in the past.

FIG. 13 is a diagram showing details of a determination process.

### DESCRIPTION OF EMBODIMENTS

Hereinafter, a vehicle control system, a vehicle control method, and a vehicle control program according to embodiments of the present invention will be described with reference to the drawings.

### First Embodiment

### [Entire Configuration]

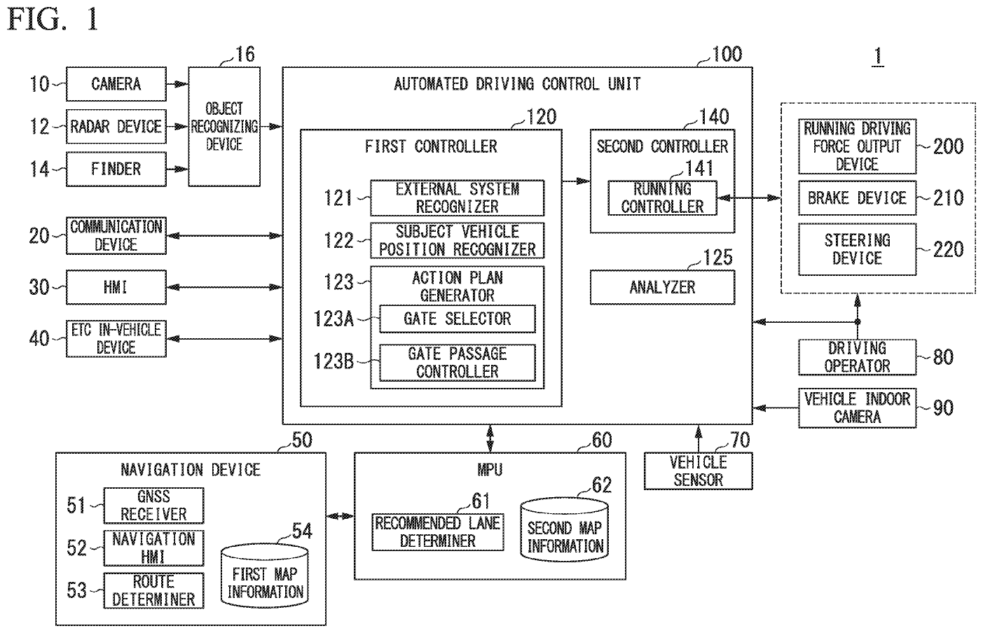

FIG. 1 is a configuration diagram of a vehicle system 1 including an automated driving control unit 100. A vehicle in which the vehicle system 1 is mounted is, for example, a vehicle having two wheels, three wheels, four wheels, or the like, and a driving source thereof is an internal combustion engine such as a diesel engine or a gasoline engine, an electric motor, or a combination thereof. An electric motor operates using power generated using a power generator connected to an internal combustion engine or discharge power of a secondary cell or a fuel cell.

The vehicle system 1, for example, includes a camera 10, a radar device 12, a finder 14, an object recognizing device 16, a communication device 20, a human machine interface (HMI) 30, an electronic toll collection system (ETC) in-vehicle device 40, a navigation device 50, a micro-processing unit (MPU) 60, a vehicle sensor 70, a driving operator 80, a vehicle indoor camera 90, an automated driving control unit 100, a running driving force output device 200, a brake device 210, and a steering device 220. Such devices and units are interconnected using a multiplex communication line such as a controller area network (CAN) communication line, a serial communication line, a radio communication network, or the like. In addition, the configuration shown in FIG. 1 is merely one example, and thus, some components may be omitted, and, furthermore, another component may be added thereto.

The camera 10, for example, is a digital camera using a solid-state imaging device such as a charge coupled device (CCD) or a complementary metal oxide semiconductor (CMOS). One or a plurality of cameras 10 are installed at arbitrary places in a vehicle (hereinafter, referred to as a subject vehicle M) in which the vehicle system 1 is mounted. In a case in which the side in front is to be imaged, the camera 10 is installed at an upper part of a front windshield, a rear face of a rear-view mirror, or the like. The camera 10, for example, repeatedly images the vicinity of the subject vehicle M periodically. The camera 10 may be a stereo camera.

The radar device 12 emits radiowaves such as millimeter waves to the vicinity of the subject vehicle M and detects at least a position (a distance and an azimuth) of an object by detecting radiowaves (reflected waves) reflected by the object. One or a plurality of radar devices 12 are installed at arbitrary places in the subject vehicle M. The radar device 12 may detect a position and a speed of an object using a frequency modulated continuous wave (FM-CW) system.

The finder 14 is a light detection and ranging or a laser imaging detection and ranging (LIDAR) finder that detects a distance to a target by measuring light scattered from emitted light. One or a plurality of finders 14 are installed at arbitrary places in the subject vehicle M.

The object recognizing device 16 may perform a sensor fusion process on results of detection using some or all of the camera 10, the radar device 12, and the finder 14, thereby recognizing a position, a type, a speed, and the like of an object. The object recognizing device 16 outputs a result of recognition to the automated driving control unit 100.

The communication device 20, for example, communicates with other vehicles present in the vicinity of the subject vehicle M using a cellular network, a Wi-Fi network, Bluetooth (registered trademark), dedicated short range communication (DSRC), or the like or communicates with various server apparatuses through a radio base station.

The HMI 30 presents various types of information to a vehicle occupant of the subject vehicle M and receives an input operation performed by a vehicle occupant. The HMI 30 includes various display devices, a speaker, a buzzer, a touch panel, a switch, a key, and the like.

The ETC in-vehicle device 40 exchanges information of an entrance tollgate, an exit tollgate, and the like by communicating with an ETC road-side device. The ETC in-vehicle device 40 includes a mounter in which an ETC card is mounted, a detector that detects whether or not an ETC card has been mounted in the mounter, a radio communicator that communicates with an ETC road-side device disposed at a gate of a toll road, a notifier, and an ETC controller. The ETC card is a medium in which authentication information (AI) used for the subject vehicle M to pass through a toll road is stored. The radio communicator may be configured to be common with the communication device 20.

The mounter includes an insertion/pulling-out mechanism capable of mounting and pulling out an ETC card. One of a state in which an ETC card is mounted and a state in which an ETC card is pulled out in the mounter is detected by the detector. The detector outputs a result of detection to the automated driving control unit 100 on the basis of control executed by the ETC controller. In addition, the detector may include a functional unit that detects validity or invalidity of an ETC card based on the term of validity and the like of the ETC card. In such a case, the detector may determine a state in which an ETC card is mounted in a case in which the ETC card is valid and determine a state in which no ETC card is mounted in a case in which the ETC card is invalid.

The radio communicator transmits authentication information stored in the ETC card to the ETC road-side device on the basis of control executed by the ETC controller. The radio communicator acquires information of passage/no-passage of a gate in which an ETC road-side device is disposed and an entrance tollgate, an exit tollgate, and the like on the basis of a result of authentication received from the ETC road-side device. The ETC road-side device determines an amount of charge for a vehicle occupant of the subject vehicle M on the basis of the information received from the ETC in-vehicle device and progresses a billing process.

The notifier is a speaker that outputs a voice, an indicator, or the like. The notifier notifies the vehicle occupant of a mounting state of an ETC card and a result of the authentication acquired by the radio communicator.

The navigation device 50, for example, includes a global navigation satellite system (GNSS) receiver 51, a navigation HMI 52, and a route determiner 53 and stores first map information 54 in a storage device such as a hard disk drive (HDD) or a flash memory. The GNSS receiver identifies a position of the subject vehicle M on the basis of signals received from GNSS satellites. The position of the subject vehicle M may be identified or complemented by an inertial navigation system (INS) using an output of the vehicle sensor 70. The navigation HMI 52 includes a display device, a speaker, a touch panel, a key, and the like. A part or the whole of the navigation HMI 52 and the HMI 30 described above may be configured to be shared. The route determiner 53, for example, determines a route from a location of the subject vehicle M identified by the GNSS receiver 51 (or an input arbitrary location) to a destination input by a vehicle occupant using the navigation HMI 52 by referring to the first map information 54. The first map information 54, for example, is information in which a road form is represented by respective links representing a road and respective nodes connected using the links. The first map information 54 may include a curvature of each road, point of interest (POI) information, and the like. The route determined by the route determiner 53 is output to the MPU 60. In addition, the navigation device 50 may perform route guidance using the navigation HMI 52 on the basis of the route determined by the route determiner 53. Furthermore, the navigation device 50, for example, may be implemented by a function of a terminal device such as a smartphone or a tablet terminal carried by a user. In addition, the navigation device 50 may transmit a current location and a destination to a navigation server through the communication device 20 and acquire a route received from the navigation server as a reply.

The MPU 60, for example, functions as a recommended lane determiner 61 and maintains second map information 62 in a storage device such as an HDD or a flash memory. The recommended lane determiner 61 divides a route provided from the navigation device 50 into a plurality of blocks (for example, divides the route into blocks of 100 m in the advancement direction of the vehicle) and determines a target lane for each block by referring to the second map information 62. The recommended lane determiner 61 determines which lane to run from the left side. In a case in which a branching place, a merging place, or the like is present in the route, the recommended lane determiner 61 determines a recommended lane such that the subject vehicle M can run on a reasonable route for advancement to divergent destinations.

The second map information 62 is map information having an accuracy higher than that of the first map information 54. The second map information 62, for example, includes information of the center of respective lanes, information on boundaries between lanes, or the like. In addition, in the second map information 62, road information, traffic regulations information, address information (address and zip code), facilities information, telephone information, and the like may be included. In the road information, information representing a type of road such as an expressway, a toll road, a national highway, or a prefectural road and information such as the number of lanes of a road, a width of each lane, a gradient of a road, a position of a road (three-dimensional coordinates including longitude, latitude, and a height), a curvature of the curve of a lane, locations of merging and branching points of lanes, a sign installed on a road, and the like are included. The second map information 62 may be updated as is necessary by accessing another device using the communication device 20.

In addition, in the second map information 62, information representing aspect of roads near an entrance tollgate and an exit tollgate is stored. The information representing aspects of a road, for example, is information including information relating to lanes, information relating to a width, a sign of the road, and the like.

The vehicle sensor 70 includes a vehicle speed sensor detecting a speed of the subject vehicle M, an acceleration sensor detecting an acceleration, a yaw rate sensor detecting an angular velocity around a vertical axis, an azimuth sensor detecting the azimuth of the subject vehicle M, and the like.

The driving operator 80, for example, includes an acceleration pedal, a brake pedal, a shift lever, a steering wheel, and other operators. A sensor detecting the amount of an operation or the presence/absence of an operation is installed in the driving operator 80, and a result of the detection is output to one or both of the automated driving control unit 100 and the running driving force output device 200, the brake device 210, or the steering device 220.

The vehicle indoor camera 90 images an upper body half by focusing on the face of a vehicle occupant sitting on a driver seat. An image captured by the vehicle indoor camera 90 is output to the automated driving control unit 100.

The automated driving control unit 100, for example, includes a first controller 120, an analyzer 125, and a second controller 140. Each of the first controller 120, the analyzer 125, and the second controller 140 is implemented by a processor such as a central processing unit (CPU) executing a program (software). In addition, some or all of the functional units may be implemented by hardware such as a large scale integration (LSI), an application specific integrated circuit (ASIC), a field-programmable gate array (FPGA), or the like or may be implemented by cooperation between software and hardware.

The first controller 120, for example, includes the external system recognizer 121, the subject vehicle position recognizer 122, and an action plan generator 123.

The external system recognizer 121 recognizes states of surrounding vehicles such as positions, speeds, and accelerations on the basis of information input from the camera 10, the radar device 12, and the finder 14 through the object recognizing device 16. The position of a surrounding vehicle may be represented as a representative point of the surrounding vehicle such as the center of gravity, a corner, or the like and may be represented by an area represented by the contour of the surrounding vehicle. The “state” of a surrounding vehicle may include an acceleration or a jerk or may be an “action state” (for example, the vehicle is changing lanes or is to change lanes) of the surrounding vehicle. In addition, the external system recognizer 121 may recognize positions of a guard rail and a telegraph pole, a parked vehicle, a pedestrian, and other objects in addition to the surrounding vehicles.

The subject vehicle position recognizer 122, for example, recognizes a lane (running lane) in which the subject vehicle M is running and a relative position and a posture of the subject vehicle M with respect to the running lane. The subject vehicle position recognizer 122, for example, by comparing a pattern (for example, an array of solid lines and broken lines) of a road partition line that is acquired from the second map information 62 with a pattern of the road partition line in the vicinity of the subject vehicle M that is recognized from an image captured by the camera 10, recognizes a running lane. In the recognition, the position of the subject vehicle M acquired from the navigation device 50 and a processing result acquired using the INS may be added.

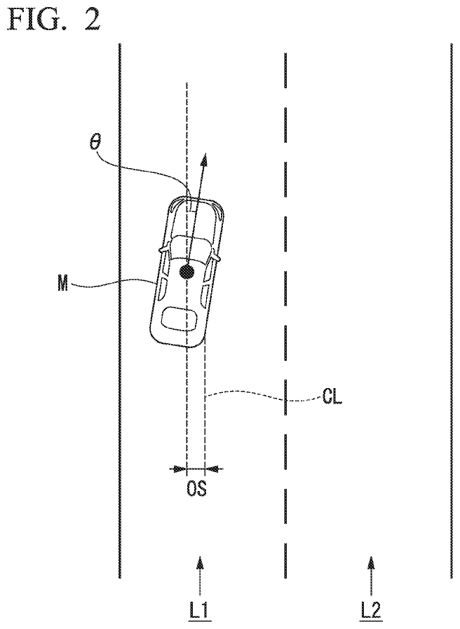

Then, the subject vehicle position recognizer 122, for example, recognizes a position and a posture of the subject vehicle M with respect to the running lane. FIG. 2 is a diagram showing a view in which a relative position and a posture of a subject vehicle M with respect to a running lane L1 are recognized by the subject vehicle position recognizer 122. The subject vehicle position recognizer 122, for example, recognizes an offset OS of a reference point (for example, center of gravity) of the subject vehicle M from running lane center CL and an angle θ of an advancement direction of the subject vehicle M formed with respect to a line acquired by aligning the running lane center CL as a relative position and a posture of the subject vehicle M with respect to the running lane L1. In addition, instead of this, the subject vehicle position recognizer 122 may recognize a position of the reference point of the subject vehicle M with respect to one side end of its own lane L1 or the like as a relative position of the subject vehicle M with respect to the running lane. The relative position of the subject vehicle M recognized by the subject vehicle position recognizer 122 is provided for the recommended lane determiner 61 and the action plan generator 123.

The action plan generator 123 determines events to be sequentially executed in automated driving such that the subject vehicle M runs in a recommended lane determined by the recommended lane determiner 61 and deals with to a surrounding status of the subject vehicle M. As the events, for example, there are a constant-speed running event in which the subject vehicle runs at a constant speed in the same running lane, a following running event in which the subject vehicle follows a vehicle running ahead, a lane changing event, a merging event, a branching event, an emergency stop event, a handover event for ending automated driving and switching to manual driving, and the like. In addition, during the execution of such an event, there are cases in which an action for avoidance is planned on the basis of surrounding statuses of the subject vehicle M (the presence/absence of surrounding vehicles and pedestrians, lane contraction according to road constriction, and the like).

The action plan generator 123 generates a target locus in which the subject vehicle M will run in the future. The target locus, for example, includes a speed factor. For example, a plurality of reference times in the future may be set for every predetermined sampling time (for example, a fraction of a [sec]), and the target locus is generated as a set of target positions (locus points) that the subject vehicle is to reach at such reference times. For this reason, in a case in which a gap between locus points is large, this represents high-speed running in a section between the locus points.

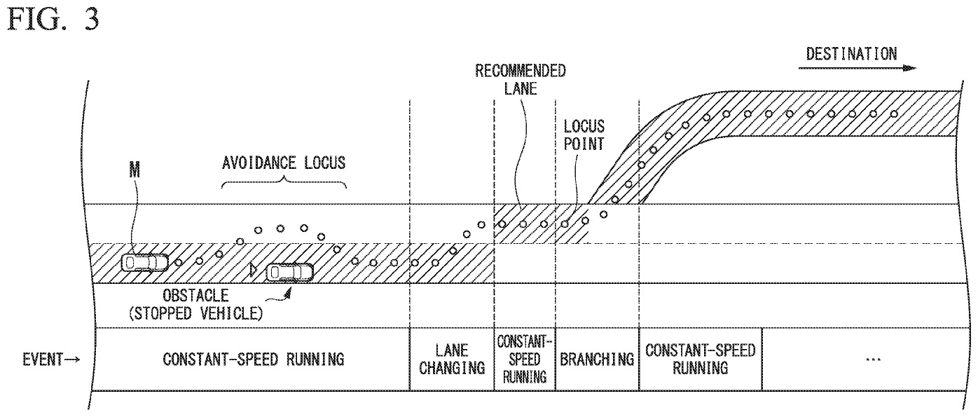

FIG. 3 is a diagram showing a view in which a target locus is generated on the basis of a recommended lane. As shown in the drawing, the recommended lane is set such that it is convenient for the subject vehicle to run along a route to a destination. When the subject vehicle reaches a position before a predetermined distance from a switching point of a recommended lane switching place (may be determined in accordance with a type of event), the action plan generator 123 starts the lane changing event, the branching event, the merging event, or the like. In a case in which there is a need for avoiding an obstacle during the execution of each event, as shown in the drawing, an avoidance locus is generated.

The action plan generator 123, for example, generates a plurality of candidates of a target locus and selects a target locus that is optimal at that time point on the basis of the viewpoints of safety and efficiency.

The action plan generator 123, for example, includes a gate selector 123A and a gate passage controller 123B. Details of processes of such functional units will be described later. A combination of the gate selector 123A, the gate passage controller 123B, and the analyzer 125 is one example of a “vehicle control system.”

The analyzer 125 acquires information representing aspects of a road (a shape of a road and a road surface sign) in an image and information of a position of a vehicle and the like by analyzing the image acquired by the communication device 20.

The second controller 140 includes a running controller 141. The running controller 141 controls the running driving force output device 200, the brake device 210, and the steering device 220 such that the subject vehicle M passes through a target locus generated by the action plan generator 123 at a scheduled time.

The running driving force output device 200 outputs a running driving force (torque) for allowing a vehicle to run to driving wheels. The running driving force output device 200, for example, includes a combination of an internal combustion engine, an electric motor, a transmission gear, and the like and an ECU controlling such components. The ECU controls the components described above on the basis of information input from the running controller 141 or information input from the driving operator 80.

The brake device 210, for example, includes a brake caliper, a cylinder delivering hydraulic pressure to the brake caliper, an electric motor generating hydraulic pressure in the cylinder, and a brake ECU. The brake ECU controls the electric motor on the basis of the information input from the running controller 141 or the information input from the driving operator 80 such that a brake torque associated with a braking operation is output to each vehicle wheel. The brake device 210 may include a mechanism that delivers a hydraulic pressure generated in accordance with an operation for a brake pedal included in the driving operator 80 to the cylinder through a master cylinder as a backup. In addition, the brake device 210 is not limited to the configuration described above and may be an electronic control-type hydraulic brake device that delivers a hydraulic pressure of the master cylinder to the cylinder by controlling an actuator on the basis of information input from the running controller 141.

The steering device 220, for example, includes a steering ECU and an electric motor. The electric motor, for example, changes the direction of the steering wheel by applying a force to a rack and pinion mechanism. The steering ECU changes the direction of the steering wheel by driving the electric motor in accordance with information input from the running controller 141 or information input from the driving operator 80.

### [Details of Gate Selector and Gate Passage Controller]

The gate selector 123A selects a gate associated with a path into which to merge after passage of the gate among a plurality of gates in accordance with a merging status of vehicles after passage of the gate. The gate passage controller 123B controls the subject vehicle such that it passes through the gate selected by the gate selector 123A.

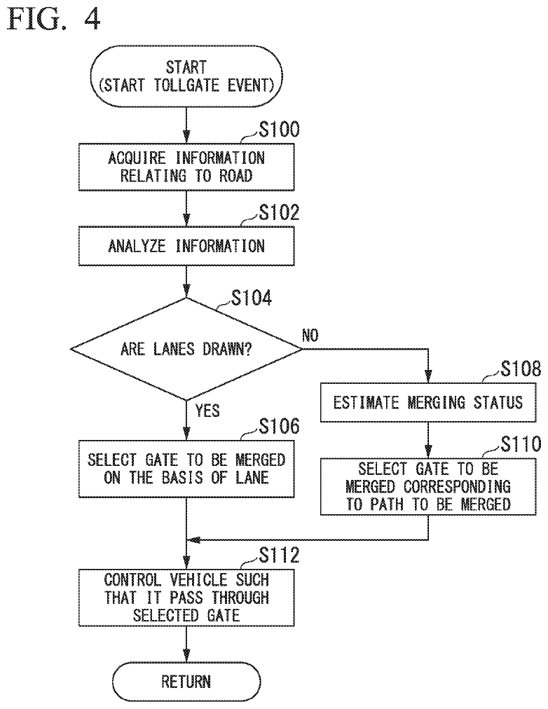

FIG. 4 is a flowchart showing the flow of a process executed by the gate selector 123A and the gate passage controller 123B. The process of this flowchart is executed when a tollgate event is started. For example, the action plan generator 123 starts a tollgate event at a predetermined distance in front of a tollgate. In addition, in a case in which a start position representing a position at which the tollgate event is started is associated with the second map information 62, the action plan generator 123 starts the tollgate event in a case in which the subject vehicle M has reached a position associated with the start position.

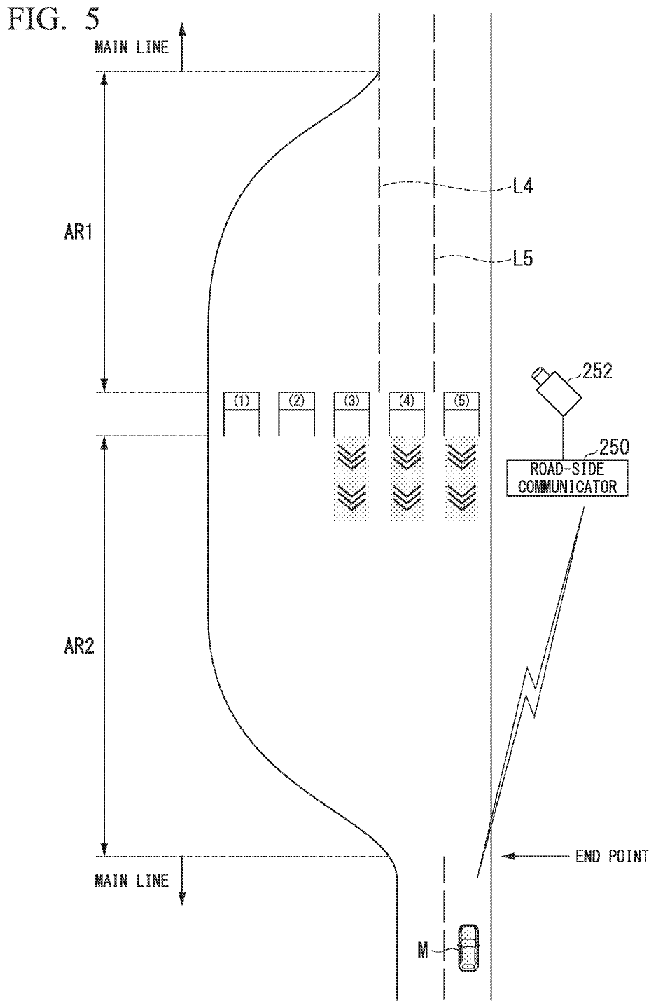

First, the gate selector 123A acquires information relating to a road after passage of a gate of a tollgate (Step S100). The information relating to a road is information including information representing aspects of the road, the position of a vehicle, and the like. The gate selector 123A, for example, acquires information relating to a road from a road-side communication device 250 (see FIG. 5 to be described later) disposed near the gate using the communication device 20. The road-side communication device 250 transmits an image captured by the camera 252 (see FIG. 5 to be described later) imaging an area of the inner side of the gate (an area in which the vehicle runs after passing the gate) to the communication device 20 as information relating to a road. In addition, the communication device 20 may acquire information relating to a road from a server apparatus or the like connected to a network using radio communication or the second map information 62. In addition, information relating to a road may be acquired on the basis of an image captured by the camera 10 or a result of detection acquired by the radar device 12.

Next, the analyzer 125 analyzes the information relating to a road acquired in Step S100 (Step S102). In addition, the camera 152 may acquire information relating to a road including a road surface sign, a vehicle state, and the like by analyzing the captured image. In such a case, the road-side communication device 250 transmits the information relating to a road acquired from the image to the communication device 20.

Next, the gate selector 123A determines whether or not lanes are drawn on the road after the passage of the gate on the basis of a result of the analysis of Step S102 (Step S104). Here, a lane is one example of a “sign.”

In a case in which lanes are drawn on the road after the passage of the gate, the gate selector 123A selects a gate through which to merge that associated with the path into which to merge on the basis of the lanes (Step S106). A gate through which to merge is a gate that is a preferential passage target of the subject vehicle M. A path into which to merge is a path representing a behavior of a vehicle coming to merge from another path among two or more paths into which to merge when the behavior of the vehicle is estimated or detected in an area in which vehicles merge.

FIG. 5 is a diagram showing one example of a view in which a gate associated with a lane is selected. The example shown in the drawing, for example, is one example of a view in which gates (1) to (5) are disposed, and a subject vehicle M runs on an inner side from the front side of the gates. An area between a main line of the inner side of the gates and the gates will be referred to as an inner-side area AR1, and an area between a main line of the front side of the gates and the gates will be referred to as a front-side area AR2.

For example, the gate selector 123A acquires information relating to a road of the inner-side area AR1 before reaching an end point of a main line (for example, a point at which a partition line of the main line disappears). As information relating to a road of the inner-side area AR1, the gate selector 123A acquires information representing that partition lines L4 and L5 associated with a gate (4) are drawn, information representing that a partition line L5 associated with a gate (5) is drawn, and information representing that partition lines associated with gates (1) to (3) are not drawn. The gate selector 123A selects a gate that has the shortest distance from the current position of the subject vehicle M for which a partition line that is not crossed is drawn in the case of entering a main line after passage of the gate as a gate through which to merge. In the example shown in the drawing, the subject vehicle M, for example, selects the gate (5).

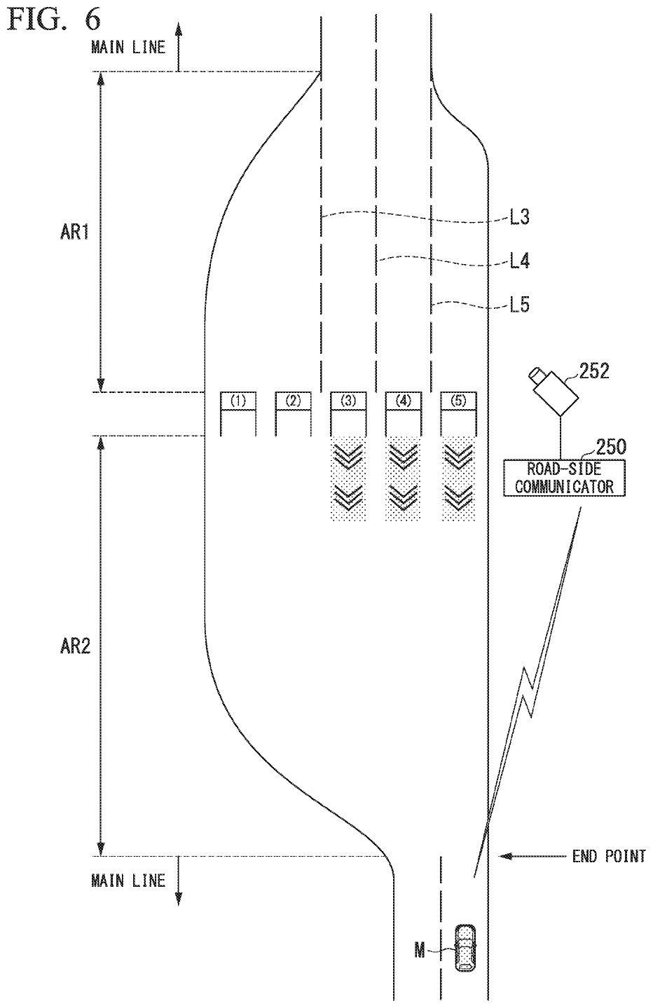

FIG. 6 is a diagram showing another example of a view in which a gate associated with a lane is selected. Description that is a duplicate to the description presented with reference to FIG. 5 will be omitted. For example, as information relating to a road of the inner-side area AR1, the gate selector 123A acquires information representing that partition lines L3 and L4 associated with a gate (3) are drawn, information representing that partition lines L4 and L5 associated with a gate (4) are drawn, and information representing that a partition line L5 associated with a gate (5) is drawn. In this case, the gate selector 123A selects a gate (4) that has the shortest distance from the current position of the subject vehicle M for which a partition line that is not crossed is drawn in the case of entering a main line after passage of the gate as a gate through which to merge.

The description will now return to FIG. 4. In a case in which no lane is drawn on a road after passage of the gates, the gate selector 123A estimates a merging status of the inner-side area AR1 on the basis of the information relating to a road (Step S108). Next, the gate selector 123A selects a gate through which to merge associated with the path into which to merge on the basis of a result of the estimation (Step S110). Next, the gate passage controller 123B controls the subject vehicle M such that it passes through the gate through which to merge which has been selected in Step S110 (Step S112). Hereinafter, a technique for selecting a gate associated with a path into which to merge using the gate selector 123A on the basis of a result of the estimation will be described.

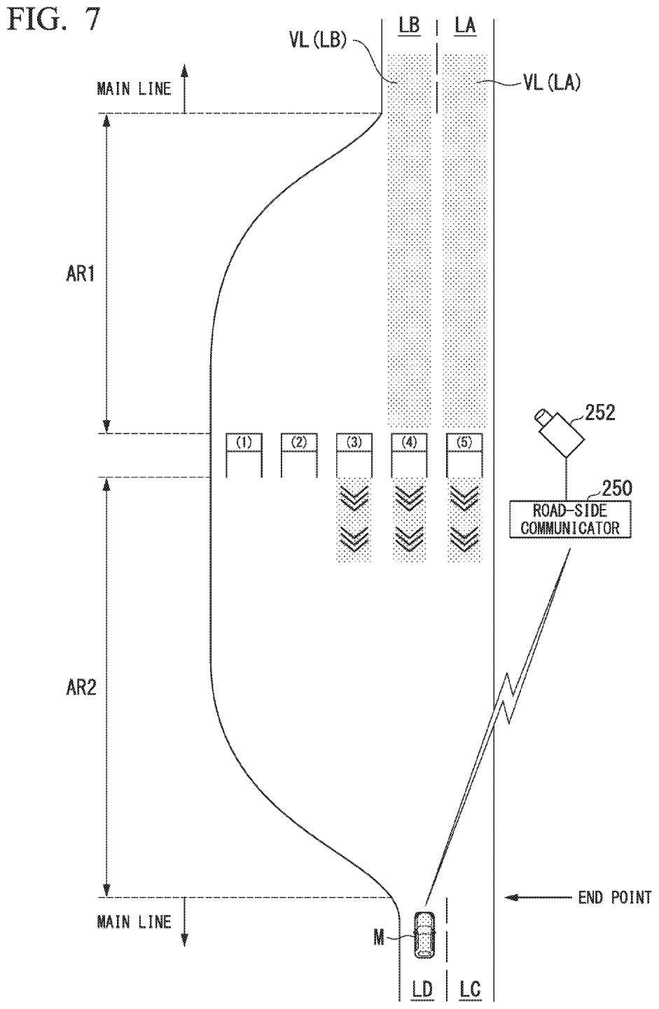

FIG. 7 is a diagram (1) showing selection of a gate through which to merge. The gate selector 123A selects a gate that overlaps areas VL(LA) and VL(LB) acquired by virtually extending main lines LA and LB on the front side after passage of the gate as a gate through which to merge. In the example shown in the drawing, gates (4) and (5) overlapping the areas VL(LA) and VL(LB) are gates through which to merge. In a case in which a plurality of gates overlap a virtual lane, a gate having a higher degree of overlapping may be selected as a gate associated with a path into which to merge. In a case in which the subject vehicle M is running in a lane LD at the main line of the front side, the gate selector 123A selects a gate (4) that is the closest from the main line of the front side in which the subject vehicle M is running.

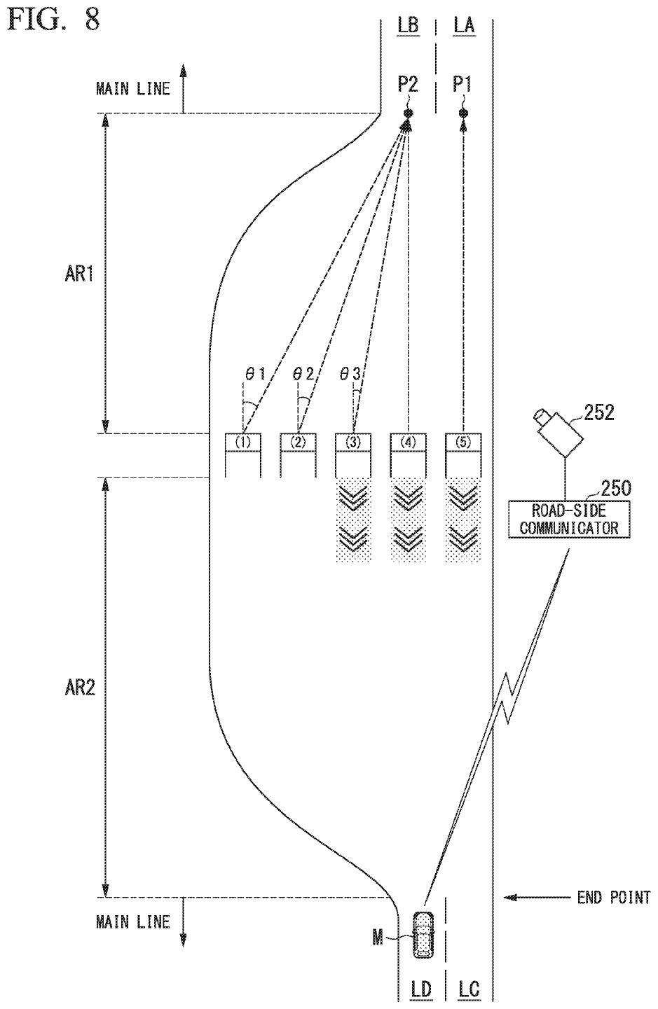

FIG. 8 is a diagram (2) showing selection of a gate through which to merge. For example, the gate selector 123A may derive a distance between a reference point of each lane of the main line of the inner side of each gate and a reference point of each gate on the basis of information stored in the high-accuracy map information 62 and select a gate for which the derived distance is the shortest as a gate to be merged. A reference point, for example, is information stored in the second map information 62. In the example shown in the drawing, for a reference point P1, a distance between the reference point P1 and a gate (5) is shorter than a distance between the reference point P1 and any other gate. In addition, for a reference point P2, a distance between the reference point P2 and a gate (4) is shorter than a distance between the reference point P2 and any other gate. For this reason, the gate selector 123A selects the gate (4) and the gate (5) as gates associated with a path into which to merge. Then, in a case in which the subject vehicle M is running along a lane LD at a main line of the front side, the gate selector 123A selects the gate (4) that is close to the main line of the front side at which the subject vehicle M is running.

In addition, the gate selector 123A may select a gate to pass further on the basis of angles (for example, θ1 to θ3) formed by virtual lines joining reference points of gates and a reference point of the main line and an extending line acquired by virtually extending the main line. For example, in a plurality of gates, in a case in which distances between the gates and the reference point of the main line are of the same degree, a gate of which the intersecting angle described above is the smallest is selected.

In this way, a gate through which to merge can be selected in the same way as when it is selected on the basis of distances, and a change in the behavior of the subject vehicle M after passage of the gate can be inhibited.

In addition, the gate selector 123A may execute the above-described techniques for selecting a gate in combination and select a gate through which to merge by integrating results of the execution.

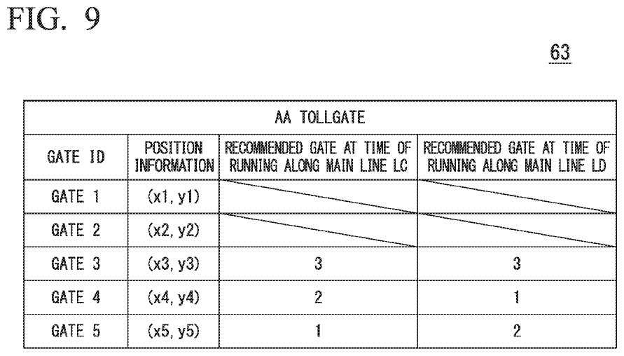

In addition, tollgate information 63 in which a gate recommended for selection on the basis of the concepts described above with reference to FIGS. 5 to 8 is described in advance may be stored in the second map information 62. FIG. 9 is a diagram showing one example of the tollgate information 63. In the tollgate information 63, for example, information of a gate recommended for selection when passing through the tollgate is included in addition to information relating to gates (a gate ID and position information). The example shown in the drawing is information of a recommended gate that is recommended when a gate is passed using the ETC in-vehicle device 40. The information of a recommended gate is set for each main line of the front side at which the vehicle is running. In the example shown in the drawing, in a case in which the subject vehicle M is running at a main line LD of the front side shown in FIG. 8, a gate that is most recommended for passage is a gate (4), and in a case in which the subject vehicle M is running at the main line LC of the front side shown in FIG. 8, it is set in the tollgate information 63 that a gate most recommended for passage is a gate (5).

According to the first embodiment described above, the gate passage controller 123B can smoothly control the vehicle after passage of a gate by controlling the subject vehicle M when it passes through a gate through which to merge associated with a path into which to merge that is selected by the gate selector 123A in accordance with a merging status between vehicles after passage of the gate.

### Second Embodiment

Hereinafter, a second embodiment will be described. In the first embodiment, the gate selector 123A selects a gate to pass through on the basis of the lane of the inner-side area AR1 of the gate or the estimated merging status. In contrast to this, in a second embodiment, a gate selector 123A selects a gate on the basis of loci along which other vehicles have run in the inner-side area AR1 in the past. Hereinafter, the description will focus on points different from those of the first embodiment.

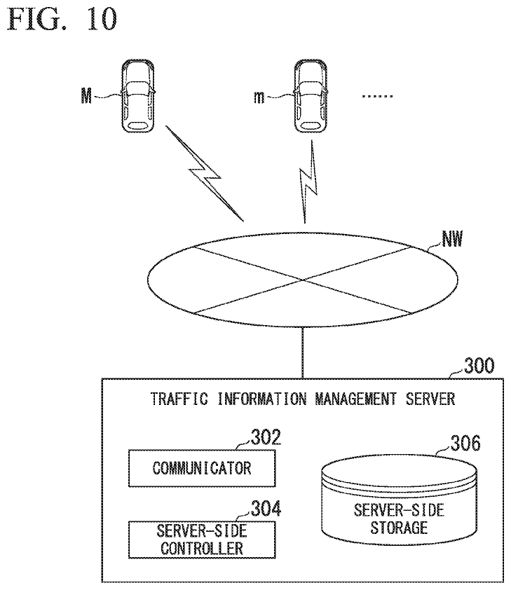

FIG. 10 is a diagram showing one example of a traffic information providing system including a subject vehicle M in which a vehicle system 1 is mounted. The traffic information providing system includes a subject vehicle M, one or more other vehicles m, and a traffic information management server 300. In another vehicle m, for example, at least a communication device communicating with the traffic information management server 300 and a device having a function for identifying the position of the vehicle are mounted. The other vehicle m in which such devices are mounted transmits position information of the vehicle to the traffic information management server 300.

For example, communication using a network NW is performed between a vehicle including one or both of the subject vehicle M and another vehicle m and the traffic information management server 300. The network NW, for example, includes a cellular network, a Wi-Fi network, a wide area network (WAN), a local area network (LAN), the Internet, a dedicated line, a radio base station, a provider, and the like.

The traffic information management server 300 manages traffic information based on information transmitted by a vehicle, a detection result acquired by a vehicle detecting sensor (for example, a camera) disposed on a road, and the like. In addition, the traffic information management server 300, by using the network NW described above, distributes managed traffic information to vehicles at predetermined intervals and transmits traffic information to a request source in accordance with a request from a vehicle.

The traffic information management server 300, for example, includes a communicator 302, a server-side controller 304, and a server-side storage 306. The server-side controller 304 is implemented by a processor executing a program. In addition, the server-side controller 304 may be implemented by hardware such as an LSI, an ASIC, or the like or may be implemented by a combination of software and hardware. The server-side storage 306 is implemented by a ROM, a RAM, an HDD, a flash memory, or the like.

The communicator 302 acquires information by communicating with a vehicle. The communicator 302 acquires a vehicle ID of a vehicle (identification information of the vehicle) and position information representing a position of the vehicle together with a transmission time at which the information has been transmitted. Hereinafter, such information will be referred to as “vehicle information.”

The server-side controller 304 transmits information relating to vehicle information to a subject vehicle M in response to a request from the subject vehicle M. In this case, by referring to the vehicle information using a link designated by a request as a search key, the server-side controller 304 derives position information of another vehicle at the designated link and provides the derived position information to the subject vehicle M.

The gate selector 123A selects a gate associated with a path into which to merge in the inner-side area AR1 on the basis of the position information of another vehicle transmitted by the traffic information management server 300.

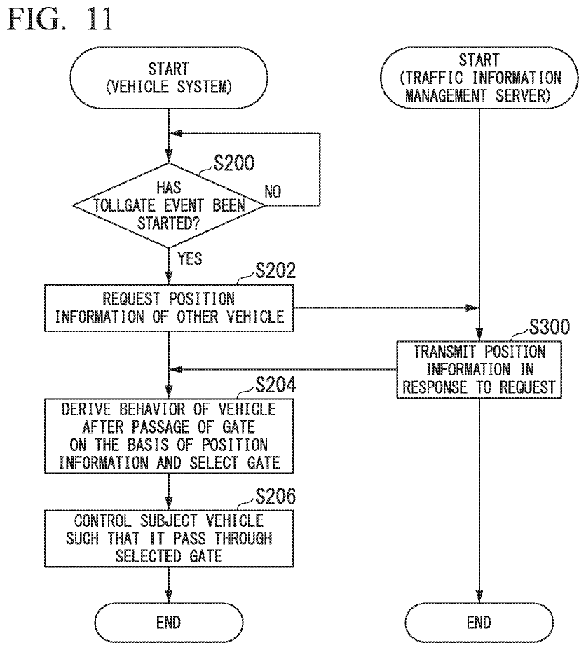

FIG. 11 is a flowchart showing a flow executed by the vehicle system 1 and the traffic information management server 300. First, the gate selector 123A of the vehicle system 1 waits until a tollgate event starts (Step S200). When the tollgate event starts, the gate selector 123A requests the traffic information management server 300 to transmit the position information of other vehicles m (Step S202). Here, the position information of other vehicles m requested by the gate selector 123A is position information of other vehicles m that have passed through the inner-side area AR1 between a predetermined time before the current time and the current time.

Next, the server-side controller 304 of the traffic information management server 300 transmits position information of other vehicles stored in the server-side storage 306 to the vehicle system 1 in response to a request transmitted by the gate selector 123A (Step S300). Next, the gate selector 123A derives a path into which to merge in the inner-side area AR1 on the basis of the position information transmitted by the traffic information management server 300 and selects a gate associated with the derived path (Step S204). Then, the gate passage controller 123B controls the subject vehicle M such that it passes through the selected gate (Step S206). In this way, the process of this flowchart ends.

In addition, although the traffic information management server 300 has been described as transmitting the position information of other vehicles m to the vehicle system 1 in the above example, instead of this, the server-side controller 304 of the traffic information management server 300 may derive a path into which to merge or select a gate associated with the path into which to merge. In this case, the gate selector 123A acquires information relating to the path into which to merge or a gate associated with the path into which to merge from the traffic information management server 300 and selects a gate to pass on the basis of the acquired information.

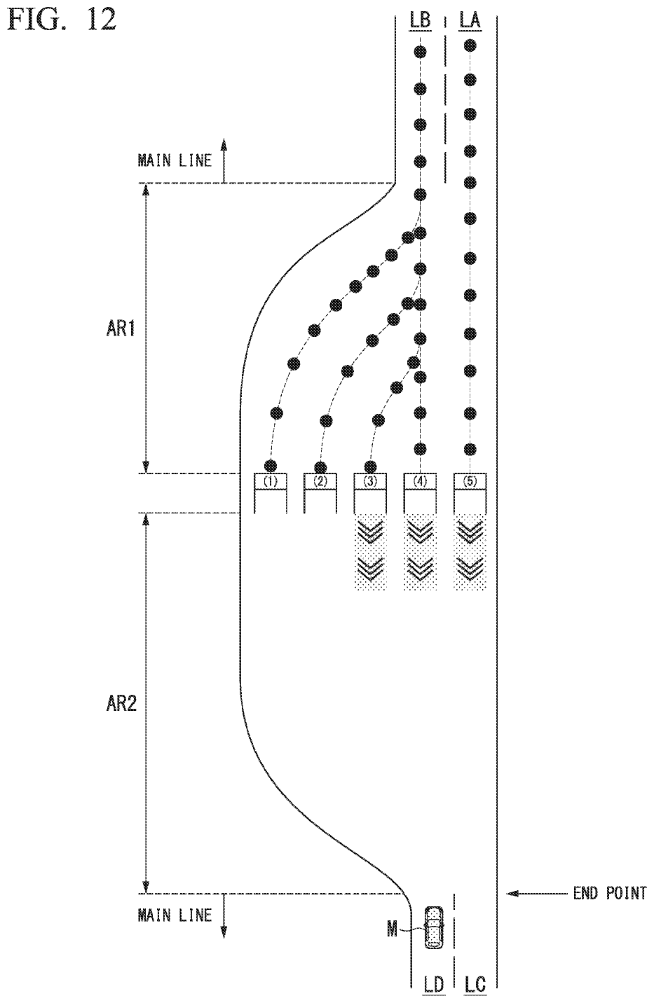

FIG. 12 is a diagram showing one example of loci along which vehicles have run in an inner-side area AR1 in the past. The gate selector 123A derives a path into which to merge on the basis of movement loci when other vehicles m have passed through the inner-side area AR1 which are acquired from the traffic information management server 300. In the drawing, black circles are acquired by averaging movement loci of other vehicles m that have run in the inner-side area AR1 after passing through each gate between a predetermined time before the current time and the current time, which have been acquired from the traffic information management server 300 and represent points on loci acquired at predetermined sampling intervals after passage of the gate. In a case in which a sum value of absolute values of angles formed by each vector between points on a locus with respect to a previous vector (associated with a turning angle on the points) is equal to or larger than a reference value, the gate selector 123A determines that the path is not a path into which to merge.

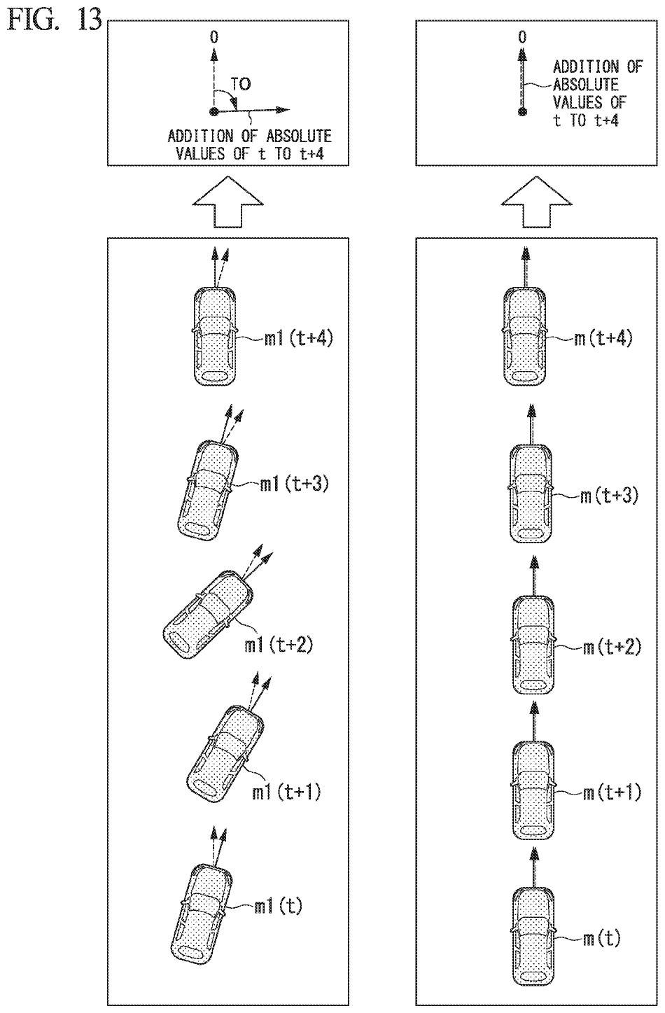

FIG. 13 is a diagram showing details of the determination process. In the drawing, advancement directions at a time t are advancement directions of other vehicles m and m1 immediately after passing through the gate, and directions at a time t+4 are advancement directions of the other vehicles m and ml when entering the main line. The gate selector 123A derives angles formed between the advancement directions of the other vehicles m and m1 acquired for every predetermined sampling interval and the advancement directions of the other vehicles m and ml before one sampling and adds absolute values of the derived angles, thereby being able to derive degrees of changes in yaw angles of the other vehicles m and ml that have passed a predetermined gate. The gate selector 123A selects a gate through which the other vehicle of which a degree of change in the yaw angle is low or equal to or lower than a predetermined degree has passed as a gate to be merged among other vehicles that have passed through each gate. In the example shown in the drawing, the gate selector 123A selects a gate through which the other vehicle m of which a degree TO of change in the added yaw angle is low has passed as a gate to be merged. In addition, the gate selector 123A may select a gate to be merged on the basis of a maximum yaw angle seen in the advancement direction at a departure point (immediately after passage of the gate).

In the example shown in the drawing, other vehicles that have passed through a gate (5) tend to go straight and enter a main line LA of the inner side, and other vehicles that have passed through a gate (4) tend to go straight and enter a main line LB of the inner side. In addition, other vehicles that have passed through gates (1) to (3) run while turning to the right side and move to merge into a movement locus of the other vehicles that have passed through the gate (4).

In this way, movement loci of the other vehicles m that have passed through the gates (1) to (3) move to the main line while being merged into the movement locus of the other vehicles that have passed through the gate (4), and accordingly, the gate selector 123A estimates that a path derived on the basis of the movement locus of the other vehicles m that have passed through the gate (4) as described above is a path to be merged. In addition, the movement locus of the other vehicle that have passed through the gate (5) moves to the main line without being merged into the movement locus of the other vehicles m that have passed through the other gates, and accordingly, the gate selector 123A estimates that also a path derived on the basis of the movement locus of the other vehicles m that have passed through the gate (5) as described above is a path to be merged.

The gate selector 123A selects the gate (4) having the shortest distance from the current position of the subject vehicle M among gates associated with a path to be merged as a gate through which the subject vehicle M is to pass. Then, the gate passage controller 123B controls the subject vehicle M such that is passes through the gate selected by the gate selector 123A.

In addition, in the example described above, while a path to be merged has been described to be derived on the basis of positions of the other vehicles m in the past, in addition to (or instead of this), a path to be merged may be derived with past speeds or past accelerations of other vehicles m being taken into account. For example, the gate selector 123A derives a change in (an average value of) speeds or accelerations of the other vehicles m that passed through each gate and entered the main line on the basis of the movement loci. The gate selector 123A estimates a gate through which the other vehicle m, of which the derived change in the speed or the acceleration is small, has passed as a gate to be merged that associated with a path to be merged. The reason for this is that, in a case in which a vehicle is running along a path to be merged, in order to be merged to a path to be merged, the vehicle tends to accelerate or decelerate more than in a case in which the vehicle is running along the path to be merged.

In addition, in addition to (or instead of) the past movement loci of the other vehicles m, a gate may be selected on the basis of information of a direction indicator turned on by the other vehicle m after passage of the gate. In such a case, the gate selector 123A sets a path along which the other vehicle m that has entered the main line without turning on the direction indicator as a path into which to merge and selects a gate through which the other vehicle m that has run along the path into which to merge as a gate through which the subject vehicle M passes. For example, the traffic information management server 300 acquires information relating to turning-on of the direction indicator of the other vehicle m that has passed through a gate and transmits the acquired information relating to turning-on of the direction indicator of the other vehicle m to the vehicle system 1. Accordingly, the vehicle system 1 can acquire the information relating to turning-on of the direction indicator of the other vehicle m.

In addition, the movement locus may be acquired from an image captured by the camera 252. In such a case, the vehicle system 1 acquires the image captured by the camera 252 from the road-side communication device 250. The gate selector 123A, for example, acquires the direction of a vehicle that has entered the main line after passage of a gate at predetermined intervals in the inner-side area AR1 for each of the other vehicles m that have passed through each gate.

According to the second embodiment described above, the gate selector 123A selects a gate through which the subject vehicle M is to pass on the basis of loci of the other vehicles that ran in the inner-side area AR1 in the past and accordingly, a path to be merged according to a traffic situation can be selected

In addition, the processes according to the first embodiment and the second embodiment may be executed in parallel. In such a case, the gate selector 123A selects a gate to be merged by integrating two processing results.

While forms for performing the present invention has been described using the embodiments, the present invention is not limited to such embodiments at all, and various modifications and substitutions may be made within a range not departing from the concept of the present invention.

1. A vehicle control system comprising:
a gate selector configured to select a gate associated with a path into which to merge after passage of the gate among a plurality of gates in accordance with a merging status between vehicles after passage of the gate; and
a gate passage controller configured to control a subject vehicle such that the subject vehicle passes through the gate selected by the gate selector.

2. The vehicle control system according to claim 1, wherein the gate selector is configured to select a gate on the basis of an aspect of a road after passage of the gate.

3. The vehicle control system according to claim 2, wherein the aspect of the road includes at least one of a shape of the road and a sign of the road.

4. The vehicle control system according to claim 1, wherein the gate selector is configured to select a gate overlapping an area acquired by virtually extending a main line after passage of the gate to a front side.

5. The vehicle control system according to claim 1, wherein the gate selector is configured to select a gate on the basis of behaviors of other vehicles in the past.

6. A vehicle control system comprising:
a gate selector configured to select a gate through which a subject vehicle is to pass on the basis of an aspect of a road after passage of the gate; and
a gate passage controller configured to control the subject vehicle such that the subject vehicle passes through the gate selected by the gate selector.

7. A vehicle control method using an in-vehicle computer, the vehicle control method comprising:
selecting a gate associated with a path into which to merge after passage of the gate among a plurality of gates in accordance with a merging status between vehicles after passage of the gate; and
controlling a subject vehicle such that the subject vehicle passes through the selected gate.

8. (canceled)

9. The vehicle control system according to claim 2, wherein the gate selector is configured to select a gate overlapping an area acquired by virtually extending a main line after passage of the gate to a front side.

10. The vehicle control system according to claim 3, wherein the gate selector is configured to select a gate overlapping an area acquired by virtually extending a main line after passage of the gate to a front side.

11. The vehicle control system according to claim 2, wherein the gate selector is configured to select a gate on the basis of behaviors of other vehicles in the past.

12. The vehicle control system according to claim 3, wherein the gate selector is configured to select a gate on the basis of behaviors of other vehicles in the past.

13. The vehicle control system according to claim 4, wherein the gate selector is configured to select a gate on the basis of behaviors of other vehicles in the past.
